(19) United States
(12) Patent Application Publication
(10) Pub. No.: US 2007/0264226 A1
(43) Pub. Date: Nov. 15, 2007

(54) Synergistically enhanced disinfecting solutions

(76) Inventors: Hampar L. Karagoezian, San Juan Capistrano, CA (US); John Park, Santa Ana, CA (US)

Correspondence Address: STETINA BRUNDA GARRED & BRUCKER, 75 ENTERPRISE, SUITE 250, ALISO VIEJO, CA, 92656, US

(21) Appl. No.: 11/800,853

(22) Filed: May 8, 2007

Related U.S. Application Data
(60) Provisional application No. 60/799,380, filed on May 10, 2006.
(60) Provisional application No. 60/830,251, filed on Jul. 12, 2006.

(51) Int. Cl. A01N 25/00; A01N 59/08; A01N 37/18

(52) U.S. Cl. 424/78.27; 424/661; 514/625; 424/405

(57) ABSTRACT

Synergistically enhanced disinfecting solutions comprising sodium chlorite in the range of 10 about ppm to about 5000 ppm and myristamidopropyl dimethylamine in the range of about 0.05 ppm to about 500 ppm for. In addition, synergistically enhanced disinfecting solutions comprising myristamidopropyl dimethylamine in the range of 0.05 ppm to 500 ppm and polyhexamethylene biguanide in the range of about 0.01 ppm to about 100 ppm for.

### CROSS-REFERENCE TO RELATED APPLICATIONS

This application claims the benefit of U.S. Provisional Application No. 60/799,380, filed on May 10, 2006, as well as U.S. Provisional Application No. 60/830,251, filed on Jul. 12, 2006, the teachings of both are herein expressly incorporated by reference.

### STATEMENT RE: FEDERALLY SPONSORED RESEARCH/DEVELOPMENT

Not Applicable

### BACKGROUND

1. Field of the Invention

The present invention relates generally to disinfecting solutions. More particularly, the present invention relates to synergistically enhanced disinfecting solutions for use as a) a multipurpose contact lens disinfecting solution, b) an antibacterial/bactericidal/antiviral/antifungal agent for disinfecting skin and/or the eye, c) a preparation for the treatment of decubitus and other skin diseases, and d) a multipurpose hard surface disinfectant cleansing solution.

2. Description of the Related Art

The prior art has included numerous antimicrobial agents which have purportedly been useable for disinfection of various articles and/or for topical application to a living being for antisepsis and/or treatment of dermal disorders (e.g., wounds, burns, abrasions, infections) wherein it is desirable to prevent or deter microbial growth to aid in healing. Such topical antimicrobial agents have contained a variety of active microbicidal ingredients such as iodine, mercurochrome, hydrogen peroxide, and chlorine dioxide.

Chlorite, a precursor of chlorine dioxide, is known to be useable as a disinfectant for drinking water and as a preservative for contact lens care solutions. However, chlorite exhibits only weak microbicidal activity within a concentration range that is acceptable and safe for topical application to the skin (e.g., 50-1000 parts per million). Thus, chlorite has not been routinely used as an active microbicidal ingredient in preparations for topical application to the skin.

Antibiotic compounds have also been commonly used for the therapeutic treatment of burns, wounds, and skin and eye infections. While antibiotics may provide an effective form of treatment, several dangers are often associated with the use of antibiotics in the clinical environment. These dangers may include but are not limited to: (1) changes in the normal flora of the body, with resulting “superinfection” due to overgrowth of antibiotic resistant organisms; (2) direct antibiotic toxicity, particularly with prolonged use which can result in damage to kidneys, liver and neural tissue depending upon the type of antibiotic; (3) development of antibiotic resistant microbial populations which defy further treatment by antibiotics.

While even minor wounds and abscesses can be difficult to treat in certain patients and/or under certain conditions, there are well known dermal disorders such as psoriasis and dermal ulcerations, which present particular challenges for successful treatment.

Psoriasis is a noncontagious skin disorder that most commonly appears as inflamed swollen skin lesions covered with silvery white scale. This most common type of psoriasis is called “plaque psoriasis”. Psoriasis comes in many different variations and degrees of severity. Different types of psoriasis display characteristics such as pus-like blisters (pustular psoriasis), severe sloughing of the skin (erythrodermic psoriasis), drop-like dots (guttate psoriasis) and smooth inflamed lesions (inverse psoriasis).

The cause of psoriasis is not presently known, though it is generally accepted that it has a genetic component, and it has recently been established that it is an autoimmune skin disorder. Approximately one in three people report a family history of psoriasis, but there is no pattern of inheritance. There are many cases in which children with no apparent family history of the disease will develop psoriasis.

The occurrence of psoriasis in any individual may depend on some precipitating event or “trigger factor”. Examples of “trigger factors” believed to affect the occurrence of psoriasis include systemic infections such as strep throat, injury to the skin (the Koebner phenomenon), vaccinations, certain medications, and intramuscular injections or oral steroid medications. Once something triggers a person's genetic tendency to develop psoriasis, it is thought that in turn, the immune system triggers the excessive skin cell reproduction.

Skin cells are programmed to follow two possible programs: normal growth or wound healing. In a normal growth pattern, skin cells are created in the basal cell layer, and then move up through the epidermis to the stratum corneum, the outermost layer of the skin. Dead cells are shed from the skin at about the same rate as new cells are produced, maintaining a balance. This normal process takes about 28 days from cell birth to death. When skin is wounded, a wound healing program is triggered, also known as regenerative maturation. Cells are produced at a much faster rate, theoretically to replace and repair the wound. There is also an increased blood supply and localized inflammation. In many ways, psoriatic skin is similar to skin healing from a wound or reacting to a stimulus such as infection.

Lesional psoriasis is characterized by cell growth in the alternate growth program. Although there is no wound at a psoriatic lesion, skin cells (called “keratinocytes”) behave as if there is. These keratinocytes switch from the normal growth program to regenerative maturation. Cells are created and pushed to the surface in as little as 2-4 days, and the skin cannot shed the cells fast enough. The excessive skin cells build up and form elevated, scaly lesions. The white scale (called “plaque”) that usually covers the lesion is composed of dead skin cells, and the redness of the lesion is caused by increased blood supply to the area of rapidly dividing skin cells.

Although there is no known cure for psoriasis, various treatments have been demonstrated to provide temporary relief in some patients. However, the effectiveness of the currently accepted treatments for psoriasis is subject to considerable individual variation. As a result, patients and their physicians may have to experiment and/or combine therapies in order to discover the regimen that is most effective. The currently available treatments for psoriasis are often administered in step-wise fashion. Step 1 treatments include a) topical medications (e.g., topical steroids, topical retinoids), b) systemic steroids, c) coal tar, d) anthralin, e) vitamin D3, and sunshine. Step 2 treatments include a) phototherapy (e.g., ultraviolet radiation), b) photochemotherapy (e.g., a combination of a topically applied radiation-activated agent followed by radiation to activate the agent) and c) combination therapy. Step 3 treatments include a) systemic drug therapies such as methotrexate, oral retinoids and cyclosporin and b) rotational therapy.

Dermal ulcerations are known to occur as a result of pressure, wear, or primary/secondary vascular disorders. A decubitus ulcer or pressure sore is a lesion caused by unrelieved pressure resulting in damage of the underlying tissue. Decubitus ulcers usually develop over a bony prominence such as the elbow or hip. The unrelieved pressure, along with numerous contributing factors, leads to the skin breakdown and persistent ulcerations.

Venous ulcers may result from trauma or develop after chronic venous insufficiency (CVI). In CVI, venous valves do not close completely, allowing blood to flow back from the deep venous system through the perforator veins into the superficial venous system. Over time, the weight of this column of blood causes fluid and protein to exude into surrounding tissues, resulting in swollen, hyperpigmented ankles, tissue breakdown, and ulceration. Venous ulcers may be shallow or extend deep into muscle. Leg ulcers also can develop in patients with arterial insufficiency caused by arterial vessel compression or obstruction, vessel wall changes, or chronic vasoconstriction. Smokers face an especially high risk of arterial disease because nicotine constricts arteries, encourages deposits of atherosclerotic plaque, and exacerbates inflammatory arterial disease (Buerger's disease) and vasoconstrictive disease (Raynaud's disease or phenomenon). Arterial ulcers, caused by trauma to an ischemic limb, can be very painful. Arterial insufficiency can be the cause of a nonhealing ulcer in a patient with diabetes. However, most diabetic ulcers result from diabetic neuropathy—because the patient cannot feel pain in his foot, he is unaware of injuries, pressure from too-tight shoes, or repetitive stress that can lead to skin breakdown.

Whenever a contact lens is removed from an eye, it should be placed in a soaking and disinfecting solution until it is worn again. Soaking and disinfecting solutions have the following functions: 1) to assist in cleaning the lens of ocular secretions after the lens is removed form the eye; 2) to prevent eye infections by a bacterial contaminated lens; and 3) to maintain the state of hydrated equilibrium, which the lens achieves while it is being worn.

During lens wear mucus material, lipids and proteins accumulate on contact lenses, making lens wear uncomfortable due to irritation, burning sensation, and redness. Accordingly, vision becomes blurry. To alleviate the discomforting problem, the soft or rigid contact lenses should be taken out of the eye, to be cleaned and disinfected regularly, using an enzymatic cleaner and a disinfecting solution. One of the serious complications associated with soft lenses can be a Giant Papillary Conjunctivitis (GPC). It is believed to be that the occurrence of the giant papillary conjunctivitis is mostly due to an inflammatory reaction associated with soft contact lens complication. This is almost always caused by protein deposits on contact lenses. GPC produces symptoms ranging from asymptomatic to itching, upper eye-lid edema, red eye, mucoid discharge, progressive contact lens intolerance. The in-the-eye cleaner of the present invention effectively cleans the protein deposits and maintains corneal epithelial cells healthy by keeping the corneal surface from microbial infection as well as by supplying molecular oxygen. Thereby, it provides convenience and benefits to both soft and rigid contact lens wearers.

Dry eye is a syndrome in which tear production is inadequate or tear composition is inappropriate to properly wet the cornea and conjunctiva. A variety of disorders of the ocular tears causes sensations of dryness of the eyes, discomfort of presence of a foreign object to occur in the eye. In most instances, the tear film loses its normal continuity and breaks up rapidly so that it cannot maintain its structure during the interval between spontaneous blinks. All of those tear abnormalities may have multiple causes. Perhaps the most common form of dry eye is due to a decreased aqueous component in the tears. Untreated dry eye can be further deteriorated to produce more severe epithelial erosion, strands of epithelial cells, and local dry spots on the cornea, which can be further complicated by microbial infection. In its mild form, however, a feeling of dryness and irritation of the eye can be solved with artificial tears. Thus, artificial tear solution which has a broad spectrum antimicrobial activity with corneal lubricating property, can provide not only comfort but also beneficial effects on recovery of damaged corneal surface.

Airborne or hand borne allergens usually produce allergic conjunctivitis due to IgE-mediated hypersensitivity reaction. It presents itching, tearing, dry and sticky eyes, including lid-swelling, conjunctival hyperemia, papillary reaction, chemosin, and ropy mucoid discharge. The presence of hyaluronic acid in the tear, which is included in the formulation of artificial tear, would protect corneal surface from contacting the allergens. The broad spectrum antimicrobial agent of the present invention keeps the corneal surface from bacterial infection and also maintains the corneal epithelial cells healthy by supplying molecular oxygen. Thus, it provides beneficial effects on the eyes sensitive to allergens.

Bacterial keratitis is one of the leading causes of blindness in the world. In the United States, an estimated 30,000 cases occur annually, with the popularity of contact lens wear having contributed to a rising incidence in the developed world. Statistical investigation indicates that about 30 of every 100,000 contact lens wearers develop ulcerative keratitis annually in the United States, thus making the disease a significant public health issue in view of potential blindness that can occur. While eyelids, blinking of the eyelids, and corneal and conjunctival epithelial cells provide barriers to microbial invasion, one or more of these defense mechanisms can become compromised. Such compromises can include lid abnormalities, exposure of the corneal surface, poor tear production, epithelial problems, medication toxicity, trauma, and incisional surgery. Ocular manifestations of bacterial keratitis are found in staphylococcus and streptococcus infections that tend to cause severe infiltration and necrosis which over time can lead to perforation. Pseudomonal keratitis tends to progress rapidly. This organism produces destructive enzymes, such as protease, lipase, and elastase, and exotoxins, which result in necrotic ulceration and perforation. Serratia keratitis starts as a superficial para-central ulcer, with the secretion of exotoxins and protease which can produce aggressive ulceration and perforation. In order for the bacterial keratitis to become established, microbial adhesions must bind to host cell receptors. Once this attachment has occurred, the destructive process of inflammation, necrosis, and angiogenesis can ensue.

Present treatment for bacterial keratitis relies primarily upon the use of broad spectrum antibiotic therapy. Such antibiotics include sulfonamides, trimethaprin, and quinolones. Also included are beta-lactams, penicillins, cephalasporins, aminoglycosides, tetracyclines, chloramphenicol, and erythromycin. While such antibiotics are in wide spread use, they can also become misused where antibiotic resistant pathogens emerge. Additionally, antibiotics only halt the proliferation of bacteria, but do not inhibit the activity of protease enzymes, endotoxins, or exotoxins.

Keratitis caused by the free-living amoeba Acanthamoeba is one of the most difficult ocular infections to manage successfully due to the resistance of the organism's cyst stage to most antimicrobial agents at concentrations tolerated by the cornea. In the past, polyhexamethylene biguanide (PHMB) as a 0.02% topical solution has been used for the treatment of acanthamoeba keratitis. Although the use of PHMB has dramatically improved the treatment of acanthamoeba keratitis, relapse still occurs in a significant portion of patients necessitating prolonged and intensive medical therapy even after treatment with PHMB. A 0.01% myristamidopropyl dimethylamine (MAPD) topical solution has also been shown to be an improved agent in the treatment of acanthamoeba keratitis. The relatively high concentration of these treating agents, however, may lead to adverse reactions in patients, including but not limited to, epithelial punctate corneal staining and tarsal conjunctival changes. As such, there is a need for an effective disinfecting agent that can be used on the skin and/or eye of a patient without causing adverse reactions.

### BRIEF SUMMARY

The present invention provides an effective synergistically enhanced disinfecting solution for use as a multipurpose contact lens disinfecting solution. The multipurpose contact lens disinfecting solution provides comfort and no adverse reactions, such as epithelial punctate corneal staining and tarsal conjunctival changes. The synergistically enhanced disinfecting solution can also be used as an antibacterial/bactericidal/antiviral/antifungal agent for skin and eye disinfection. Further, the synergistically enhanced disinfecting solution can be used as a preparation for the treatment of decubitus and other skin diseases. Additionally, the synergistically enhanced disinfecting solution can be used as a hard surface disinfectant cleanser.

The multipurpose disinfecting solution generally includes a synergistic combination of antimicrobial agents, including but not limited to, sodium chlorite and myristamidopropyl dimethylamine (MAPD) or myristamidopropyl dimethylamine (MAPD) and polyhexamethylene biguanide (PHMB). Additionally, myristamidopropyl dimethylamine dimethicone copolyol phosphate can be used in place of MAPD in the present invention without any harmful adverse effects.

MAPD is generally present in the disinfecting solution in a concentration range between about 0.05 ppm to about 500 ppm. When in the solution, sodium chlorite is generally present in a concentration range between about 10 ppm to about 5000 ppm. When in the solution, PHMB is generally present in a concentration range between about 0.01 ppm to about 100 ppm. In addition, the multipurpose disinfecting solution may optionally combine sequestering agents, surfactants, lubricating agents, tonicity agents, buffering agents, viscosity agents, protein removing agents, and/or high molecular weight polymeric agents.

### DETAILED DESCRIPTION

It has been discovered that the disinfecting solutions of the present invention containing combinations of sodium chlorite and myristamidopropyl dimethylamine (MAPD) or MAPD and polyhexamethylene biguanide (PHMB) are very effective against microbes. Additionally, the combinations of the present invention act synergistically to effect antimicrobial and bactericidal activity against acanthamoeba cysts and trophozoites at a much lower concentration of each individual antimicrobial agent than as has been previously used in conventional disinfecting solutions. Further, the combinations of the present invention act synergistically to effectuate an enhanced antiviral and antifungal activity.

In one embodiment of the present invention the disinfecting solution contains sodium chlorite and MAPD, the concentration range of sodium chlorite is from about 10 ppm to about 5000 ppm and the concentration range of MAPD is from about 0.05 ppm to about 500 ppm. A preferred embodiment includes sodium chlorite from about 10 ppm to about 1500 ppm and MAPD from about 0.05 ppm to about 50 ppm. A specific embodiment includes 400 ppm of sodium chlorite and 5 ppm of MAPD. This embodiment of the invention preferably has a pH range of about 5.5 to about 8.5, and has an even more highly preferred pH range of about 6.5 to about 7.5. One embodiment of this invention for use in ophthalmic preparations preferably has a tonicity in the range of about 200 mOsm to about 340 mOsm. Another embodiment of this invention for use in dermatological formulations preferably has a tonicity in the range of about 50 mOsm to about 5000 mOsm.

Another embodiment of the present invention envisions a disinfecting solution containing MAPD and PHMB, wherein MAPD is present from about 0.05 ppm to about 500 ppm and PHMB is present from about 0.01 ppm to about 100 ppm. A preferred embodiment includes MAPD from about 0.05 ppm to about 50 ppm and PHMB from about 0.01 ppm to about 10 ppm. A specific embodiment includes 5 ppm of MAPD and 0.5 ppm of PHMB. In this embodiment of the invention, a preferable pH range for the composition is about 5.0 to about 9.0, with a more highly preferred pH range of about 6.5 to about 7.5. One embodiment of this invention for use in ophthalmic preparations preferably has a tonicity in the range of about 200 mOsm to about 340 mOsm. Another embodiment of this invention for use in dermatological formulations preferably has a tonicity in the range of about 50 mOsm to about 5000 mOsm.

Either of the above synergistic combinations of disinfecting solutions may utilize myristamidopropyldimethylamine dimethicone copolyol phosphate in place of MAPD without any harmful adverse effects.

The antimicrobial activities of the synergistic disinfecting solutions are further enhanced by the addition of sequestering agents, such as disodium edatate (EDTA). The sequestering agents serve to reduce calcium ions and also help remove proteins. Furthermore, the addition of non-toxic and non-ionic surfactants, such as poloxamer and poloxamine, will further add to the synergistic effect of the disinfection capabilities of the present invention.

To improve contact lens wearer's comfort and acceptability, lubricating agents, tonicity agents, buffering agents, viscosity agents, and protein removing agents can be added into the present invention of the synergistic combination of antimicrobial agents for effective disinfecting solutions.

To improve skin disinfection comfort and acceptability, lubricating agents, tonicity agents, buffering agents, viscosity agents, and high molecular weight polymeric agents like sodium hyaluronate, hydroxypropylmethyl cellulose or carboxymethyl celluloses can be added into the present invention of the synergistic combination of antimicrobial agents for effective skin disinfecting solutions.

One embodiment of the present invention envisions a multipurpose disinfection composition having the following formula:

| | |
|---|---|
| sodium chlorite | 10 ppm to 5000 ppm |
| MAPD | 0.05 ppm to 500 ppm |
| sodium hyaluronate | 0.05% to 1.0% |
| boric acid | 0.05% to 5.0% |
| sodium chloride | 0.10% to 0.90% |
| EDTA | 0.005% to 0.50% |
| Poloxamer 127 | 0.10% to 5.0% |
| potassium chloride | 0.14% |
| calcium chloride dihydrate | 0.02% |
| magnesium chloride hexahydrate | 0.011% |
| purified water USP Q.S. | 100 mL |
| pH of solution | 5.5 to 8.5 |

This embodiment has the preferred following formula:

| | |
|---|---|
| sodium chlorite | 400 ppm |
| MAPD | 0.05 ppm |
| sodium hyaluronate | 0.10% |
| boric acid | 0.25% |
| sodium chloride | 0.72% |
| EDTA | 0.02% |
| Poloxamer 127 | 0.20% |
| potassium chloride | 0.14% |
| calcium chloride dihydrate | 0.02% |
| magnesium chloride hexahydrate | 0.011% |
| purified water USP Q.S. | 100 mL |
| pH of solution | 6.5 to 7.5 |

Alternatively, this embodiment may have the following formula:

| sodium chlorite | 10 ppm | to 5000 ppm |
|---|---|---|
| MAPD | 0.05 ppm | to 500 ppm |
| hydroxypropylmethyl cellulose | 0.05% | to 5.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| purified water USP Q.S. | 100 mL | |
| pH of solution | 5.5 | to 8.5 |

The preferred formulation of this embodiment is as follows:

| | |
|---|---|
| sodium chlorite | 1000 ppm |
| MAPD | 0.30 ppm |
| hydroxypropylmethyl cellulose | 0.35% |
| boric acid | 0.25% |
| sodium chloride | 0.72% |
| EDTA | 0.02% |
| Poloxamer 127 | 0.20% |
| purified water USP Q.S. | 100 mL |
| pH of solution | 6.5 to 7.5 |

Another embodiment of the present invention envisions a multipurpose disinfection composition having the following formula:

| PHMB | 0.01 ppm | to 100 ppm |
|---|---|---|
| MAPD | 0.05 ppm | to 500 ppm |
| sodium hyaluronate | 0.05% | to 1.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| potassium chloride | 0.14% | |
| calcium chloride dihydrate | 0.02% | |
| magnesium chloride hexahydrate | 0.011% | |
| purified water USP Q.S. | 100 mL | |
| pH of solution | 5.0 | to 9.0 |

This embodiment has the preferred following formula:

| | |
|---|---|
| PHMB | 0.02 ppm |
| MAPD | 0.05 ppm |
| sodium hyaluronate | 0.10% |
| boric acid | 0.25% |
| sodium chloride | 0.72% |
| EDTA | 0.02% |
| Poloxamer 127 | 0.20% |
| potassium chloride | 0.14% |
| calcium chloride dihydrate | 0.02% |
| magnesium chloride hexahydrate | 0.011% |
| purified water USP Q.S. | 100 mL |
| pH of solution | 6.5 to 7.5 |

Alternatively, this embodiment may have the following formula:

| PHMB | 0.01 ppm | to 100 ppm |
|---|---|---|
| MAPD | 0.05 ppm | to 500 ppm |
| hydroxypropylmethyl cellulose | 0.05% | to 5.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| purified water USP Q.S. | 100 mL | |
| pH of solution | 5.0 | to 9.0 |

This embodiment has the preferred following formula:

| | |
|---|---|
| PHMB | 0.10 ppm |
| MAPD | 0.30 ppm |
| hydroxypropylmethyl cellulose | 0.35% |
| boric acid | 0.25% |
| sodium chloride | 0.72% |
| EDTA | 0.02% |
| Poloxamer 127 | 0.20% |
| purified water USP Q.S. | 100 mL |
| pH of solution | 6.5 to 7.5 |

In addition, the present invention can be equally effectively used for the purpose of other disinfecting requirements such as in foods, cosmetics, medical devices, as well as dermatological pharmaceutical preparations. The present invention may also be utilized as a multipurpose hard surface disinfectant solution useful, for example, in disinfecting countertops, tables, floors, walls, sinks, and other hard surfaces that may be contaminated with bacteria, viruses, and/or fungi.

The above description is given by way of example, and not limitation. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A multipurpose disinfecting composition comprising from about 10 ppm to about 5000 ppm sodium chlorite and from about 0.05 ppm to about 500 ppm myristamidopropyl dimethylamine.

2. The multipurpose disinfecting composition of claim 1, comprising 400 ppm sodium chlorite and 5 ppm myristamidopropyl dimethylamine.

3. A multipurpose disinfecting composition comprising from about 0.05 ppm to 500 ppm myristamidopropyl dimethylamine and from about 0.01 ppm to 100 ppm polyhexamethylene biguanide.

4. The multipurpose disinfecting composition of claim 3, comprising from about 0.05 ppm to about 50 ppm myristamidopropyl dimethylamine and from about 0.01 ppm to about 10 ppm polyhexamethylene biguanide.

5. A multipurpose disinfecting composition comprising from about 10 ppm to 5000 ppm sodium chlorite and from about 0.05 ppm to about 500 ppm myristamidopropyldimethylamine dimethicone copolyol phosphate.

6. A multipurpose disinfecting composition comprising from about 0.05 ppm to 500 ppm myristamidopropyldimethylamine dimethicone copolyol phosphate and from about 0.01 ppm to 100 ppm polyhexamethylene biguanide.

7. The multipurpose disinfection composition of claim 1, wherein the composition has a pH range of about 5.5 to about 8.5.

8. The multipurpose disinfection composition of claim 1, wherein the composition has a pH range of about 6.5 to about 7.5.

9. The multipurpose disinfection composition of claim 3, wherein the composition has a pH range of about 5.0 to about 9.0.

10. The multipurpose disinfection composition of claim 3, wherein the composition has a pH range of about 6.5 to about 7.5.

11. The multipurpose disinfection composition of claim 1 comprising the formula:

| sodium chlorite | 10 ppm | to 5000 ppm |
|---|---|---|
| MAPD | 0.05 ppm | to 500 ppm |
| sodium hyaluronate | 0.05% | to 1.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| potassium chloride | 0.14% | |
| calcium chloride dihydrate | 0.02% | |
| magnesium chloride hexahydrate | 0.011% | |
| purified water USP Q.S. | 100 mL | |
| pH of solution | 5.5 | to 8.5 |

12. The multipurpose disinfection composition of claim 11 comprising the formula:

| | |
|---|---|
| sodium chlorite | 400 ppm |
| MAPD | 0.05 ppm |
| sodium hyaluronate | 0.10% |
| boric acid | 0.25% |
| sodium chloride | 0.72% |
| EDTA | 0.02% |
| Poloxamer 127 | 0.20% |
| potassium chloride | 0.14% |
| calcium chloride dihydrate | 0.02% |
| magnesium chloride hexahydrate | 0.011% |
| purified water USP Q.S. | 100 mL |
| pH of solution | 6.5 to 7.5 |

13. The multipurpose disinfection composition of claim 3 comprising the formula:

| PHMB | 0.01 ppm | to 100 ppm |
|---|---|---|
| MAPD | 0.05 ppm | to 500 ppm |
| sodium hyaluronate | 0.05% | to 1.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| potassium chloride | 0.14% | |
| calcium chloride dihydrate | 0.02% | |
| magnesium chloride hexahydrate | 0.011% | |
| purified water USP Q.S. | 100 mL | |
| pH of solution | 5.0 | to 9.0 |

14. The multipurpose disinfection composition of claim 13 comprising the formula:

| | |
|---|---|
| PHMB | 0.02 ppm |
| MAPD | 0.05 ppm |
| sodium hyaluronate | 0.10% |
| boric acid | 0.25% |
| sodium chloride | 0.72% |
| EDTA | 0.02% |
| Poloxamer 127 | 0.20% |
| potassium chloride | 0.14% |
| calcium chloride dihydrate | 0.02% |
| magnesium chloride hexahydrate | 0.011% |
| purified water USP Q.S. | 100 mL |
| pH of solution | 6.5 to 7.5 |

15. The multipurpose disinfection composition of claim 1 having a tonicity in the range of about 200 mOsm to about 340 mOsm.

16. The multipurpose disinfection composition of claim 3 having a tonicity in the range of about 200 mOsm to about 340 mOsm.

17. The multipurpose disinfection composition of claim 1 having a tonicity in the range of about 50 mOsm to about 5000 mOsm.

18. The multipurpose disinfection composition of claim 3 having a tonicity in the range of about 50 mOsm to about 5000 mOsm.

19. The multipurpose disinfection composition of claim 1 comprising the formula:

| sodium chlorite | 10 ppm | to 5000 ppm |
|---|---|---|
| MAPD | 0.05 ppm | to 500 ppm |
| hydroxypropylmethyl cellulose | 0.05% | to 5.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| purified water USP Q.S. | 100 mL | |
| pH of solution | 5.5 | to 8.5 |

20. The multipurpose disinfection composition of claim 19 comprising the formula:

| | |
|---|---|
| sodium chlorite | 1000 ppm |
| MAPD | 0.30 ppm |
| hydroxypropylmethyl cellulose | 0.35% |
| boric acid | 0.25% |
| sodium chloride | 0.72% |
| EDTA | 0.02% |
| Poloxamer 127 | 0.20% |
| purified water USP Q.S. | 100 mL |
| pH of solution | 6.5 to 7.5 |

21. The multipurpose disinfection composition of claim 3 comprising the formula:

| PHMB | 0.01 ppm | to 100 ppm |
|---|---|---|
| MAPD | 0.05 ppm | to 500 ppm |
| hydroxypropylmethyl cellulose | 0.05% | to 5.0% |
| boric acid | 0.05% | to 5.0% |
| sodium chloride | 0.10% | to 0.90% |
| EDTA | 0.005% | to 0.50% |
| Poloxamer 127 | 0.10% | to 5.0% |
| purified water USP Q.S. | 100 mL | |
| pH of solution | 5.0 | to 9.0 |

22. The multipurpose disinfection composition of claim 21 comprising the formula:

| | |
|---|---|
| PHMB | 0.10 ppm |
| MAPD | 0.30 ppm |
| hydroxypropylmethyl cellulose | 0.35% |
| boric acid | 0.25% |
| sodium chloride | 0.72% |
| EDTA | 0.02% |
| Poloxamer 127 | 0.20% |
| purified water USP Q.S. | 100 mL |
| pH of solution | 6.5 to 7.5 |
